(19) United States
(12) Patent Application Publication
(10) Pub. No.: US 2008/0319846 A1
(43) Pub. Date: Dec. 25, 2008

(54) Method and System of Electronic Couponing and Marketing

(76) Inventors: William Leming, Lemont, IL (US); Alex Leming, Chicago, IL (US)

Correspondence Address: BEEM PATENT LAW FIRM, 53 W. JACKSON BLVD., SUITE 1352, CHICAGO, IL, 60604-3787, US

(21) Appl. No.: 11/767,625

(22) Filed: Jun. 25, 2007

(51) Int. Cl. G06Q 30/00; G06F 17/30; G06F 17/40

(52) U.S. Cl. 705/14

(57) ABSTRACT

A method and system of electronic couponing and marketing where a third-party intermediary distributes coupons to consumers through a website and the retailer's existing preferred accounts. The method comprises identifying a user, linking the user to an identifier distributed by a seller, enabling the user to search a database and select coupons, associating the selected coupons with the user, allowing the user to purchase items and redeem the selected coupons, tracking information regarding the searching, selecting and redeeming, and utilizing the information to generate a marketing strategy for vendors directed to users. The system uses a computer with means for connecting to the Internet, a user identification input and a user verification protocol, a storage medium containing demographic and geographic information about the consumer, electronic coupons, and searching, selection and redemption histories of the consumer.

### BACKGROUND OF THE INVENTION

1. Field of the Invention

The invention is directed to a method and system for electronic couponing and marketing, and it may be implemented through the use of a plurality of identification readers, a plurality of preferred or discount cards, and at least one computer system having a database.

2. Description of the Related Art

According to the Association of Coupon Professionals, manufacturers increased the number of coupons they offered by 10% in 2005. Conversely, redemptions of coupons actually decreased by 6%, and internet coupons accounted for only two-tenths of one percent of all coupons distributed and redeemed in that same time span. In order to increase redemptions of coupons, thereby increasing sales of products, several attempts have been made to establish a system for the distribution of coupons electronically using the Internet. In one example, Q Interactive, Inc. operates a website at www.upons.com. The site enables a shopper that already possesses a preferred or discount card from a retailer to register for the service and search a limited number of manufacturer coupons, all of which expire two weeks from date of selection. If the shopper wants one of the coupons, the shopper selects it and it becomes associated with the shopper's preferred card so that the discount will be applied the next time (within two weeks from date of selection) the shopper scans its card at the retailer's store and purchases the product to which the coupon applies.

In another variation, European patent application EP 1,087,318 to Berstis, a database of products and coupons is made available through the Internet at either the website of a retailer or a manufacturer, or the product's website itself. The system allows a user to enter his own customer ID on a website that will then either allow him to select particular products and request coupons or see all coupons that are currently available. The retailer has registers equipped with a UPC scanner and a customer ID recognition unit, which may be the same as the scanner. At checkout, the customer swipes his card or enters his ID to allow the system to check a database to determine if a coupon should be applied.

According to the current paper coupon practice, at the end of a period of time, a retailer generally collects all the manufacturer coupons that were redeemed during that period of time and sends them to its corporate office which, in turn, ships them to its third-party vendor who sorts them by manufacturer and ships them to each appropriate manufacturer for repayment. Because, at this stage, paper coupons may be treated as consideration, manufacturers may often dislike that retailers cannot identify or control coupon clubs or coupon-swapping organizations or entities. In addition, they may distrust retailers and worry that the retailers may fraudulently submit coupons that were not redeemed as part of a sale. Few, if any, adequate audit controls currently exist to verify the accuracy of coupons redeemed and ultimately submitted for repayment against actual sales. In addition, even if no fraud occurs, the coupons are generally counted multiple times, by multiple parties to determine an amount of reimbursement, verify that amount, and generally at least double-check that amount. This slow and cumbersome process largely ignores the time-value of money, is costly to execute, and has few safeguards in it to prevent or reduce fraud at either the consumer or local retailer levels.

It would be desirable to create a method and system that overcome one or more shortcomings in the prior art and take advantage of the potential benefits presented by electronic couponing.

### BRIEF SUMMARY OF THE INVENTION

A method and system of electronic couponing and marketing are provided. The method comprises the steps of: identifying a user; linking the user to an identifier distributed by a seller to the user; enabling the user to search a database, including through the use of a website, and select coupons; associating the selected coupons with the user; allowing the user to purchase items associated with the selected coupons and redeem the selected coupons; tracking and storing information regarding the searching, selecting and redeeming of coupons by the user as well as those who intend or intended to use their individual coupons; and utilizing said information to generate a more targeted, more timely, more cost-effective, more measurable and more data-driven marketing strategy for vendors directed to users.

The method may further comprise providing the user with a record of coupons it selected. In addition, the method may comprise informing the vendors of a value of the coupons redeemed in a selected period of time to provide an audit of the coupons redeemed in that time period. In one embodiment, the method anticipates the consumer making its purchases at the retailer's location. In another embodiment, the method may be used to redeem the coupons through a website operated by the retailer or manufacturer.

The method may allow the coupons to be altered depending on geographic, demographic, behavioral, historical or other criteria associated with the consumers that search, select and redeem the coupons in order to reward the consumers for loyalty, to incent or entice them to make purchases, to test the relative success of various offers, or for any other reason. Moreover, manufacturers may be able to distribute advertisements or promotional items through the mail, via e-mail or other manner to selected consumers based on the same criteria.

The system of the present invention may comprise a user interface comprising a computer with means for connecting to the Internet, a user identification input and a user verification protocol, a storage medium containing a first set of information comprising individual, demographic and geographic information about the consumer, a second set of information comprising electronic coupons, and a third set of information comprising entries representing searching, selection and redemption histories of the consumer, as well as means for implementing the inventive method. The computer may be a personal computer, such as a desktop or laptop computer. Alternatively, the computer may be a wireless communication device such as a personal digital assistant or wireless telephone.

### BRIEF DESCRIPTION OF THE DRAWINGS

FIG. 1 is a graphical representation of one embodiment of the inventive method.

FIG. 2A is a graphical representation of another embodiment of the inventive method.

FIG. 2B is a continuation of the graphical representation of FIG. 2A.

FIG. 3 is a schematic of a system for employing the inventive method.

### DETAILED DESCRIPTION OF THE INVENTION

A method and system for using electronic couponing to enable vendors to sell more product within defined geographies at an acceptable cost, increase traffic and sales for sellers and reward consumers with lower costs is provided. In this application, vendors may generally be referred to as manufacturers and sellers may be generally referred to as retailers. The method and system fuse together the interests of retailers (to increase traffic) and manufacturers (to sell more product), which share a common objective but may also distrust each other, together through the use of a third-party managed method and system. The method and system create a collection of electronic coupons that may be robust and sortable in multiple ways by the consumer, who may also be referred to as the user. Moreover, the method and system of the present invention may offer value to retailers, manufacturers and consumers, and may attract and retain visitors, first-time users and repeat users. In addition, the method and system may provide manufacturers and retailers with a wealth of heretofore unavailable information that they may use to create plans, strategies or tactics for more effectively marketing their products to both large groups of consumers as well as smaller groups or even individual consumers, in order to appropriately and efficiently incent and/or reward frequent buyers or cost effectively attract new buyers, with the ultimate goal of increasing sales.

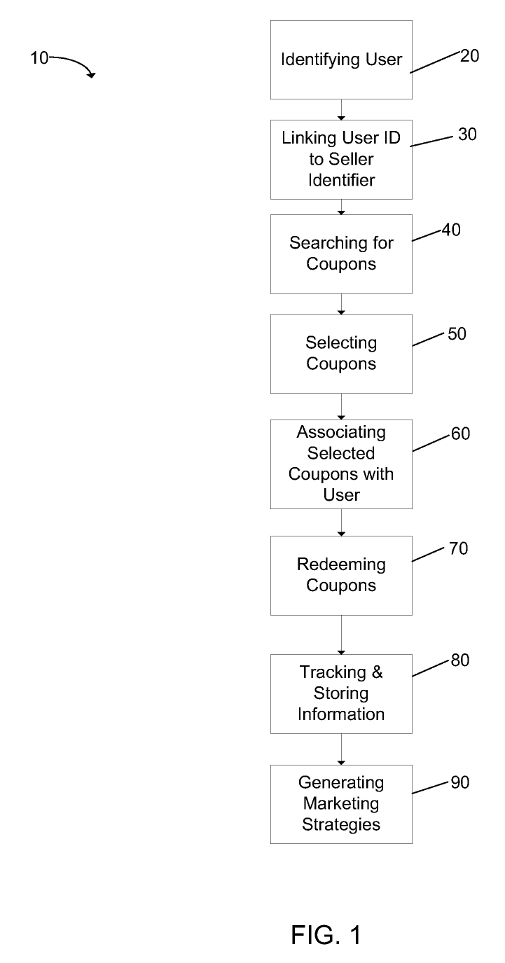

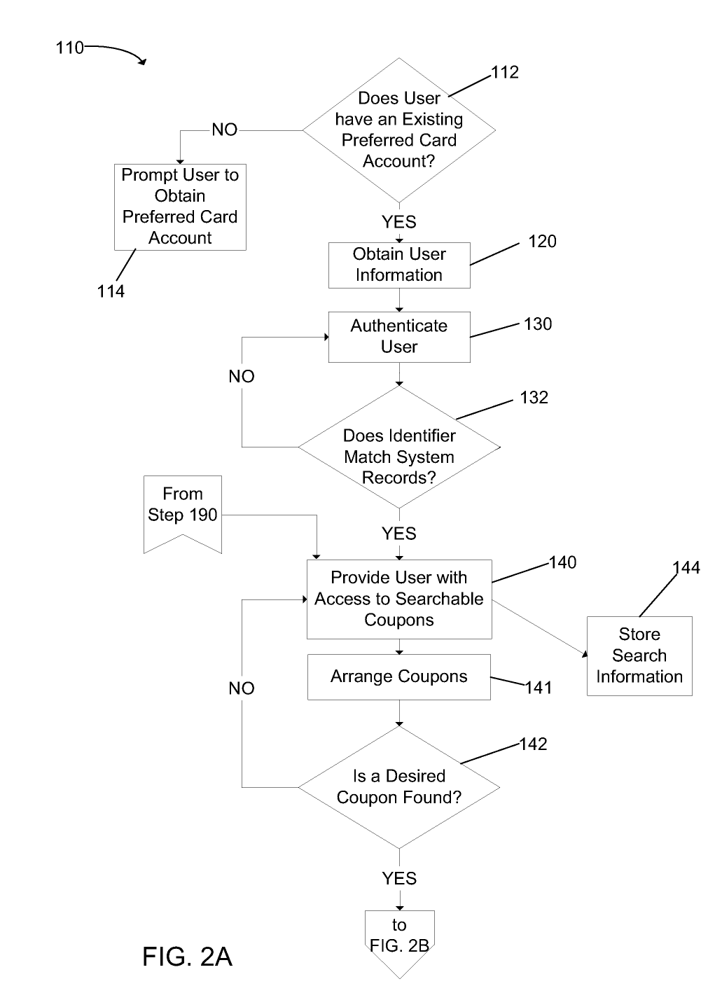

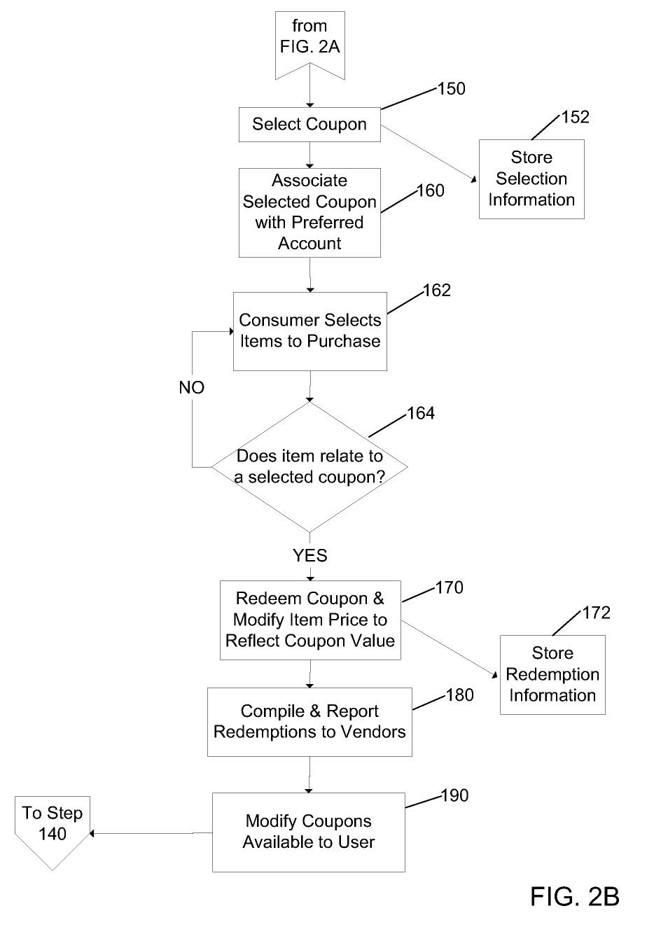

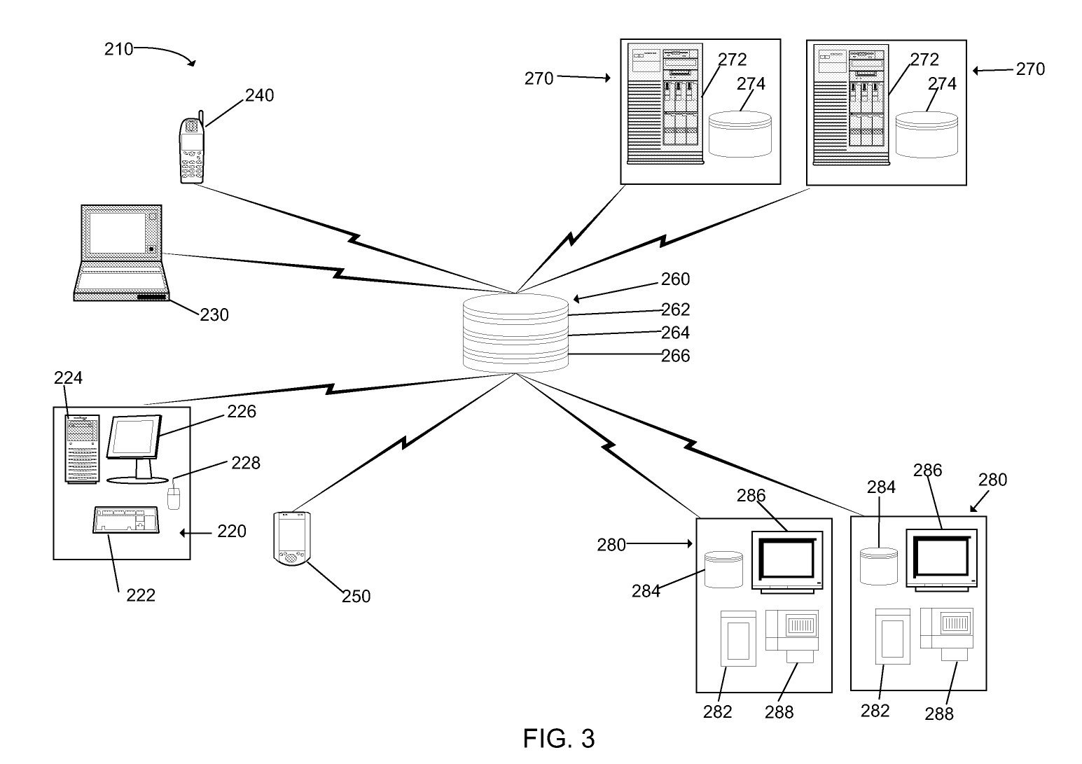

As shown in the embodiments of FIGS. 1, 2A & 2B, the method 10, 110 and the system 210, as shown in the embodiment of FIG. 3, of the present invention take advantage of existing preferred or discount programs offered by retailers. In many instances, a consumer that belongs to one of these programs is given a preferred card, their fingerprint is scanned, or some other method is provided for associating the consumer with the preferred program, identifying 20 the consumer and enabling the consumer to receive retailer's discounts on purchases made at the retailer's store or through its website. In a preferred embodiment, the access device may be the retailer's preferred customer card that is typically the property of the issuing retailer. The card may be linked to a card application containing the consumer's name, postal address, age, e-mail address, etc. Fingerprint scanning may have the advantage of allowing the consumer to access its account if it forgets its card or decides it does not want to carry the card around. For this reason, fingerprint scanning may become part of a preferred embodiment if its use becomes more prevalent. However, if it does not gain wide-spread acceptance, retailers may seek practical and efficient alternatives to incent/reward customers to carry/present their card and thereby improve the volume and accuracy of their users' purchase behavior.

It is possible to employ a new coupon card for use with multiple retailers. However, this may not be necessary as it may be easier and more convenient to use the existing preferred cards. Moreover, the present method and system may be used to purchase products online from the retailer. In this case, the user may enter a serial number or other identifier to identify itself with respect to a preferred account.

In the instant case, as shown in the embodiment of FIG. 3, a consumer uses a computer 220, a mobile telephone with Internet access 240, a personal digital assistant 250 or other similar device to access a user interface, which may be a website. The website allows the consumer to register by providing or verifying individual and demographic information such as name, gender, age, postal address, email address, etc. as well as the name of the retailer or retailers at which they wish to shop and/or the identification number associated with their preferred card. In one embodiment, the user may use preferred card identifier as its identifier on the website. In another embodiment, the two identifiers may be different. However, as shown in FIG. 1, the two identifiers may be linked 30 to each other so the present invention recognizes that they identify the same user and/or user entity, i.e. household.

Once registered, consumers may search 40 the website for coupons related to goods in which they may be interested. Coupons may come from retailers, particularly those that wish to promote private label products, but preferably coupons are provided by the manufacturer since retailers may already offer discounts through the use of their preferred card programs.

Upon finding a coupon of interest, consumers may electronically “clip” the coupon by selecting 50 it and associating 60 it with their accounts by saving the coupon while logged in. While a virtually unlimited number of coupons may be selected and stored for each consumer, preferably up to about 500 coupons may be stored at a given time. This may make it easier for the consumer to organize and keep track of the selected coupons, as well as limit the amount of storage space required for each consumer. As shown in FIG. 3, coupons may be stored in a database 260 or other data repository or storage medium. If storing the selected coupon causes the consumer to surpass the predetermined number of coupons allowed, the present invention may prompt the user that limit has been exceeded. In addition, the method and system may ask the user whether the user wants to not store the selected coupon, it may overwrite the oldest coupon, or it may ask the user whether it would prefer to delete one of the coupons that are already stored in order to make room for the new coupon.

Once a consumer has finished searching 40 the website and selects all of the coupons in which it may be interested, it may print out a list of the coupons selected in any number of available sort-order sequences chosen by the consumer. The list may allow the consumer to see what discounted items it has selected when shopping at the retailer's store, as well as see the offer expiration date for each coupon. In addition, the list may be easier to read, organize and carry around than individual paper coupons. The list may also be electronically-based, meaning that it may be accessible and transmittable via any/all electronic text and/or graphic messaging devices including but not limited to PDAs, cell phones, handheld PCs, etc.

When the consumer is ready to purchase an item, he must identify himself to the seller. In one embodiment, such as that shown in FIG. 3, he may proceed to a register and scan his preferred card, use a fingerprint scanner or some other form of identification reader 282. In another embodiment, he may use a computer interface to enter a serial number or other identifier directly. A checkout computer 280 recognizes the identification that is input, links to the database 260 hosted by the third party in which the coupons are clipped, and cross-checks the items purchased to determine whether there are any matching, valid coupons. If a valid match is found, the checkout computer 280 recognizes the amount of the coupon, redeems 70 the coupon, deducts the amount from the cost of the item and displays the coupon discount amount on the receipt printed on the printer 288. Once this has occurred, the third-party database 260 may be updated to remove the redeemed coupon from the record of available coupons associated with the consumer. However, it may also create an entry to denote that the coupon has, in fact, been redeemed.

In one embodiment of the present invention, consumer-based information may be maintained in a database 260 controlled by the third-party administrator. In comparison to a manufacturer, which has little incentive to make the method and system available to other manufacturers, and retailers, which may potentially provide inaccurate redemption information to manufacturers, the third party may serve as an impartial database administrator. The third party may control consumer and participant access, maintain historical and transactional activities, automatically and electronically delete expired coupons, prioritize enhancements such as upgrading the user interface, perform system audits, resolve reimbursement disputes, provide accurate and timely reports, control system updates or improvements, and schedule new coupon offerings and quantify relative coupon offer strength.

The user interface or webpage behind the present invention may vary in appearance depending on who is looking at it. In one embodiment, the coupons on the webpage, and the list that may be printed out once the consumer has selected the desired coupons, may be arranged to reflect the aisles of the store at which the consumer shops. In other variations, the coupons may be arranged alphabetically, by brand name, by product name, by calorie, by fat content, by carbohydrate or sugar content, by percentage off, by amount off, by out-of-pocket cost or by any other method of sorting and distinguishing products. This may add additional convenience to the shopper in both looking for coupons and looking for the actual products once at the retailer's store or website. In addition, it may provide consumers with greater product content or nutritional value information when comparing products. Moreover, the webpage may be organized to allow the consumer to see actual year-to-date, month-to-date, and enrollment-to-date total savings as a result of coupons redeemed with each visit to the site. This may make the realized savings increasingly significant, and may entice users to redeem more of the coupons they have selected than they might otherwise. In addition, the webpage may include the total potential savings for a chosen time period had the user redeemed all of the coupons it selected and display this information alongside the actual savings achieved. Visualization of this disparity may cause the user to realize the full potential of the coupons and redeem more of them at the retailer, resulting in increased sales for the retailer and manufacturer.

As shown in FIG. 1, the present invention provides that, every time a coupon is redeemed 70, the transaction may be tracked 80 and information stored regarding the transaction. The process may be accurate, inexpensive and virtually instantaneous. It may significantly reduce the handling fees paid by the manufacturer to the retailer, which are currently generally between $0.07 and $0.08 per redeemed coupon. At the end of a period of time, the identifier records for each consumer that redeemed a coupon from a given manufacturer at each given retailer location or through the retailer's website may be compiled and presented in a report for delivery to either or both the manufacturer and seller, reducing the time and expense involved in previous methods. This may greatly reduce the float time that a seller must wait in order to obtain reimbursement for the coupons from the manufacturers. In addition, it may eliminate, or at least reduce, the cost of verifying and validating coupon reimbursement amounts provided by an outside aggregator employed by a retailer and the cost to the manufacturer of verifying the reimbursement amount provided by the retailer's outside aggregator. Retailers and manufacturers may still decide to rely on register receipts to determine the value of coupons redeemed. However, even if they do so, the record may serve as an unbiased, independent third-party audit or dispute resolver to monitor, manage and verify the redemption and reimbursement system's integrity on a regular and ongoing basis.

While retailers may miss out on the handling fees received from the manufacturer for each redeemed coupon, the present method and system may enable traditional retailers to better compete with “big box” providers on price by allowing consumers to receive greater discounts on items directly from the manufacturers. These handling fees are required because of the extra costs of labor required by the paper coupon handling process, including their redemption at a register, shipment of batched coupons, and processing by an outside company to determine their value. The present method and system reduces these labor costs. Moreover, by reducing the float time, retailers may be required to wait a shorter amount of time to be reimbursed by manufacturers. Likewise, consumers may benefit due to a reduced cost for goods and an accelerated checkout process.

Retailers and manufacturers may also benefit by appealing to a broader potential consumer base. Many consumers are underserved by print media and do not receive the paper coupons distributed by manufacturers. In addition, many consumers may not want to physically clip, store and then remember to transport the coupons to a retailer in order to obtain savings. The present method and system may particularly benefit a growing number of internet savvy consumers, who, instead, may be able to more quickly select the coupons they desire and only continue to carry the discount or preferred card they already carry in order to obtain the desired savings. It also may be a benefit to consumers, manufacturers and retailers that desire an ecologically “green” way of dealing with coupons that does not entail clipping large amounts of paper and discarding potentially larger amounts of unwanted and/or expired coupons. This method and system, by cost effectively increasing the appeal of coupons to underserved population segments, should help increase retailer's market share and manufacturer's share of wallet. Moreover, it creates a convenient and potentially sizeable incentive for consumers to carry their discount or preferred cards and present them to the retailer. For consumers, this may also result in obtaining greater savings than they would have obtained if using the store's default card, as described below. For retailers this may result in more accurate transactional data.

Since retailers have already collected and stored descriptive information about the consumers in a storage medium 284 when they applied for the preferred program or account, the present invention may result in more accurate customer and household purchase and intent-to-purchase data for the retailer, more accurate customer segmentation and more compelling offers appropriate to each household. In addition, it may provide ongoing consumer file hygiene, in that consumers may be more apt to update the information associated with their card if moving, for example, in order to obtain special or customized discounts through the mail. Since these updates are customer based, i.e. voluntarily provided by consumers, this update may be a far less costly, more timely and more accurate process than traditional file grooming methods such as using matched and overlaid data like that obtained from National Change of Address.

The method and system of the present invention also collect a wealth of information that may be useful to manufacturers and/or retailers in generating 90 marketing strategies directed towards consumers. As such, it may both facilitate and encourage testable and quantifiable target marketing for both manufacturers and/or retailers via direct mail, e-mail or any other available electronic media. To do so, it may use the individual, demographic, geographic, behavioral, modeled and over-laid information that may be collected as each consumer searches for, selects and redeems coupons. This narrowcast targeting of specific consumers or groups of consumers may be beneficial as it may allow retailers and/or manufacturers to cost effectively move inventory, drive traffic and increase market share versus a traditional broadcast medium. As discussed below, this may enable the manufacturer and retailer to select the “right” customer at the “right” time using the “right” medium to receive the “right” offers in an efficient manner. In addition, because the transactions are detailed electronically, it may enable a manufacturer to quickly and accurately measure coupon offer strength, for example on a geographic basis or on a demographic basis within a selected geographic area.

The information collected may enable manufacturers to identify redeemers by name, household, demographics, behavioral criteria, model score, recency of activity, frequency of activity, amount spent, amount saved, channel preference, preferred retailer site location, geography, or any combination of these or any other distinguishing criteria known in the art. It may also enable manufacturers to identify users that saw a particular coupon or coupons within a particular time period by any of these criteria or combination of criteria, as well as users that both saw and saved or electronically “clipped” a coupon or coupons within the time period.

The method and system of the present invention may provide manufacturers with normative coupon saving and clipping data, as well as conversion and/or redemption rates, i.e. the number of redeemed coupons during a desired period divided by the number of saved or clipped coupons during the same period, within a given product line. Based on this information, manufacturers may be able to quickly ascertain how effectively their particular coupon promotions are enticing consumers to select and save or “clip” the electronic coupons. In addition, manufacturers may be able to ascertain how well their coupon promotions are enticing consumers to redeem coupons relative to previous coupon offers or to other competitor coupon offers within similar product categories during the same period.

In this way, the present invention may provide manufacturers with a relative performance metric of their coupons. For example, 2% milk as a category may generate 250,000 clipped coupons during a 2 week period with a redemption rate of 25%. If one manufacturer's 2% milk coupon during this period were clipped 25,000 times but only 15% were redeemed, this may suggest that their coupon is not being redeemed at anywhere near the overall rate for the product category, despite having a 10% coupon clipping share. This may direct the manufacturer to address possible reasons why they do not have the same level of redemption and evaluate what they may want to do to try to raise its redemption rate, test various hypotheses and quickly determine which strategies and tactics most effectively increase redemptions and move product relative to their peers.

As discussed above, the user interface may be customizable by the consumer to search for, and arrange, coupons in a manner it desires. Conversely, the method and system of the present invention may be customizable to vary the content that is initially visible to the consumer. It may allow manufacturers or brand managers to select specific consumers or groups of consumers based on criteria they desire to receive special, unique coupon offers that may or may not be generally available to the overall user base. For example, users may be selected based on their past behavior, their demographics, their propensity to purchase a particular product or class of products or other methods known in the art. This flexibility and attendant level of systemic complexity may allow manufacturers and brand managers the ability to market products more effectively.

The effect of these one-to-one or one-to-few offers may be quantifiable, like all offers, and the results of the offers may be compared to similar offers made to other segments of a desired customer base to facilitate refinement of the segmented couponing strategy leading to greater return on subsequent marketing investments. This may free manufacturers from a broadcast mass media marketing strategy, such as print media, where all offers are the same regardless of an individual consumer's buying preferences, behaviors or characteristics.

As can be seen in FIGS. 2A & 2B, a second embodiment of the inventive method is shown. Method 110 may begin with determining 112 whether the user has an existing preferred account with at least one retailer. If not, method 110 may prompt 114 user to obtain an account before proceeding. If so, the user's information, which may include individual, demographic and geographic information, is obtained 120. In order to proceed with viewing coupons, the user may be required to input an identifier and/or a password to be authenticated 130. The third-party computer system may verify whether the identifier and/or password match records stored in the system 132. If no match is made, user may be given a determined number of chances to provide proper authentication 130 before access may be suspended or revoked.

Once a user has been authenticated, the method 110 may provide the user with access 140 to the coupons stored in the third-party storage medium. Coupons may be searched and arranged 141 by the user according to various criteria as explained above, with the present invention storing 144 the search information. Based on the search results, the user may determine whether it desires any of the coupons that are shown 142. If not, the user may be able to start a new search 140 using different parameters. However, if a desired coupon is found, the user may select the coupon 150, with method 110 storing the selection information. In addition, method 110 may associate 160 the selected coupon with the user's preferred account to facilitate redemption of the coupon.

Continuing with FIGS. 2A & 2B, the consumer may then select 162 items to purchase, either at a retailer's location, on its website, or at some other location. Consumer uses his preferred account to identify himself to the checkout system and scans or otherwise identifies the item to be purchased. Once it has been identified, method 110 determines whether the item relates to a selected coupon, for example, by connecting with third-party's database to analyze the user's selected coupons stored in third-party's database. If a match is found, the coupon is redeemed 170 and method 110 may modify the item price to reflect the coupon value. In addition, third-party database may receive notification of the redemption and store 172 information regarding the redemption.

At the end of a period of time, the third party may compile and report 180 all of the redemptions for an item to the item's manufacturer in order to give the manufacturer an accurate accounting of coupons redeemed. In addition, method 110 may use the information about the user that it has gathered to modify 190 the coupons made available to the user so that different coupons may be visible and searchable 140 the next time the user accesses the storage medium.

Even though the method and system may have users throughout multiple geographies, income levels, age ranges or other demographics, the electronic coupons of the present invention may be customized or modified 190 quickly and easily to serve a manufacturer's needs. For example, a product may sell well in California but not well at all in Nebraska. Using the current invention, manufacturers may choose to offer larger discounts to consumers in Nebraska to entice them into trying the product, whereas they may be able to offer smaller discounts or no discounts to consumers in California without a significant change in sales. This may also allow manufacturers to quantify and address various seasonal sales influences in each geographic area and thereby more accurately plan, more realistically budget and more reliably forecast. It may also provide a cost effective alternative to diverting large quantities of shipped goods at a significant discount that may not be sold if the forecast is inaccurate, and may therefore reduce a manufacturer's reliance on these diverters.

In another embodiment, the method and system of the present invention are capable of tracking the viewing habits of a consumer so that a record may be made of all coupons viewed 40 but not clipped, all coupons clipped 50 but not redeemed, and all coupons that are ultimately redeemed 70. Repeat consumers may be offered special incentives or larger discounts. Consumers that have clipped a coupon but never redeemed it may be enticed with a larger discount to see if they actually will redeem it, providing a measurable means of sourcing additional sales. In this way, manufacturers may be able to utilize an electronic coupon usage history among consumers to determine what strategies and tactics may work within any particular consumer usage segment and what strategies and tactics may not. In addition, with this history established, the method and system of the current invention make it possible to know whether two people or two groups of people are comparatively similar in their demographic information, coupon selections or purchasing histories. With this knowledge, it may be possible to extend to one person or one group of people one coupon offer and extend to the other person or group of people a different offer to test the multiple offers simultaneously. For example, a manufacturer may decide to offer a first group of people a coupon for twenty-five cents off an item and a second group one dollar off the purchase of four items. The method and system of the present invention allows the manufacturer, which may operate its own computer system 270 to submit the separate coupons it may store in its own data repository 274 to the third-party operator, direct the operator which group is to receive which offer, or have the operator choose which group receives which offer, and then quickly distribute both coupon offers and quantify the relative success of each.

Although the present invention allows for multiple offers to be tested to determine the most appealing one at a given time, the invention also allows for easy reevaluation at later times to determine whether consumer preferences have changed. It may, therefore, provide the means to measure coupon offer strength or appeal in an ever-changing consumer marketplace. In addition, it may provide a more covert marketing, advertising and promotional vehicle 90 than traditional forms of mass media so that competitors may be less aware of the variety of discounts offered by a rival manufacturer while the discounts are still pending.

Because the coupons are electronic in nature, the time between a decision to offer a coupon and when that coupon reaches the consumer may be significantly less than for paper coupons. Therefore, manufacturers may be able to quickly, easily and cost-effectively test, quantify and refine various processes for increasing sales. In addition, deadlines for inclusion, changes or alterations of the coupons may be far more flexible and frequent than for traditional print media. Manufacturers may be able to see the effects of this refinement to judge whether the offers extended are the “right” offers to increase response, sales, and marketing return on investment.

As discussed above, the inventive method and system allow for flexibility in the creation and distribution of electronic coupons. For example, a manufacturer of multiple items may decide to offer a discount on a combination of items to users that may purchase both items separately, or to those that only purchase one item but may be enticed into buying the other. In another embodiment, manufacturers may be able to select or adjust the expiration dates of the coupons. For example, a manufacturer may decide to offer a larger discount on a product for a more limited time period or to offer what it considers a “standard” coupon amount for an extended period of time. In either case, the manufacturer may be given the ability to decide for itself what coupon amounts and durations it deems prudent or desirable, as well as the information necessary to adequately address that issue. This may enable the manufacturer to determine an optimum or ideal amount of time during which to make a coupon valid in any or all geographic areas for any segment or sub-segment of the user base.

Also as discussed above, although retailers and manufacturers may have the same ultimate goals of selling goods and maximizing profit, manufacturers often distrust retailers and may be wary that retailers may over-report the value or number of coupons that consumers actually redeemed. By keeping a record of all coupons that are clipped 152 and redeemed 172, the present invention may provide accountability and security for the manufacturer when dealing with retailers. This, in turn, may cause the goals of the retailers and manufacturers to be more aligned, allowing both groups to sell more products more cost effectively. It may also allow both groups to gain market share without increased labor cost, without float issues, without increasing handling fees, without increased print media costs, and without fraud or the fear of fraud. Inasmuch as electronic coupons are not transferable from one person, card or entity to another person, card or entity, it may also help control the practice of coupon-swapping among individuals, clubs or organizations.

Another aspect of the invention allows the third party to use the information collected from consumers' viewing, selecting and redeeming histories to create reporting packages detailing various market trends. For a chosen item or category of items, it may be possible to evaluate what coupon offers result in greater redemptions than others, what kinds of offers entice consumers to actually redeem the coupons they have selected, what the most effective expiration dates for coupons are to achieve an acceptable redemption rate, as well as various other marketing or promotional tools that may be contemplated in the art.

Since consumers are also members of the retailer's preferred member programs, it may be likely that retailers have already collected contact information about the consumers. When a discount offered by the retailer through its preferred card is redeemed by a consumer, the retailer may know who purchased the product, as well as where, when, how many, etc. In addition, it may know the address of the consumer in order to send more compelling promotional information or other advertising on a more targeted basis, resulting in a greater return on marketing investment.

In contrast, when paper coupons are redeemed, manufacturers have none of this information about the consumers that redeemed the coupons, despite its value. Preferably, third-party intermediary protects consumer information and does not provide or disclose it to manufacturers. However, third-party intermediary may also act as an intermediary between manufacturers and consumers. While still safe-guarding the anonymity of consumers with respect to manufacturers, the third party may accept offers, rewards or other materials from manufacturers. Then, since the third party knows the identity of the intended recipients, it may agree to forward those offers, rewards or other materials to those users. This may enable the manufacturer to communicate with its individual customers and former customers via direct mail and/or electronically based upon any demographic, behavioral, applied, calculated overlaid criteria or combination of criteria and to quickly quantify the results of each and every communication.

The present invention may be accomplished through the use of the use of a system for performing the method described above. In the embodiment of FIG. 3, the system 210 may include a user interface, which may comprise a computer 224 with means for connecting to the Internet. In one embodiment, the computer may be a personal computer, such as a desktop computer 220 or laptop computer 230. In other embodiments, the computer may be a wireless communication device, such as a personal digital assistant 250, mobile telephone 240 or other form of handheld computer. User interface may be used to connect to a website or other means for interfacing with third-party's computer systems. In addition, the interface may comprise a user identification input and a user verification protocol, such as typing a username and password when prompted, transmitting the usemame and password to the third party's system via a secure encryption algorithm, and verifying that the username and password coincide before granting access to third party's repository of coupons.

The system of the present invention may further comprise a storage medium 260. The storage medium 260 may be a database, although any other data storage, indexing, or compilation medium may be used. In addition, multiple databases may be used, each holding discrete categories of information or portions of segments of information. In this case, the multiple databases may still comprise a single storage medium. Moreover, a single database may be used to store multiple categories of information.

In one embodiment, the storage medium may contain a category with individual, demographic and/or geographic information 262 about each consumer that registers to use the system. As explained above, this information may be useful to help determine if the consumer may receive advertising targeted to or tailored toward him. In addition, another category may be the electronic coupons submitted for dispersal to consumers and those that have been previously submitted but are expired 264 and may be held in the storage medium 260. Moreover, the storage medium may contain a category of information relating to the searching, selection and redemption histories of the consumers 266. Like the individual, demographic and geographic information 262, these histories may also be used to tailor coupons toward the consumer.

The system may further contain means for searching and selecting electronic coupons. This may be through the use a visual display 226 and keyboard 222 to type in keywords such as product names or categories. In one embodiment, coupons may be tagged with metadata that allows them to be searched for matches or probability fits to the search terms with the results displayed on the visual display of the user interface. The selection of coupons may be accomplished by using a touch-screen 226, a mouse 228 with an icon shown on the visual display 226, or other means for selecting the desired coupons. In addition, the selection may be accomplished by highlighting or checking the desired coupons, dragging them into an electronic folder, or through other means known in the art.

Once a user has selected coupons, the system may include means for associating 60 the user identification and the selected electronic coupons with the preferred or discount card account offered by the retailer that the consumer previously established. This may be accomplished by storing all of the information related to the consumer and his use history in a common location, by relating the data together in a relational database, or through other means used or known in the art.

During and after redemption of selected coupons, the system may include means for comparing an item selected by the consumer with the coupons the consumer previously selected. Retailer's computer system 280 may include a connection to third party's storage medium, such as an internet connection or a dedicated connection between retailer and third party. Once the system has verified that a selected item and a selected coupon are related, the system may have means for redeeming the coupon, which may include transmitting a value of the coupon to the retailer's system with instruction to deduct that value from the customer's balance. Moreover, in one embodiment the system may delete information relating to the redeemed coupon from the storage medium 260 and create an entry relating to redeemed coupons. This entry may be in the area dedicated to the individual consumer or, in another embodiment, may be in another section of the storage medium 260 dedicated to redeemed coupons. In another embodiment, the coupons may have status identifiers such as searched, selected and redeemed associated with them. In this embodiment, redemption of the coupon may result in the status identifier being changed from selected to redeemed.

Once the redemption has occurred, the system may allow for the total savings to be displayed to the consumer. This may be accomplished through showing the results on a visual display 226 such as a computer monitor if the user is shopping online or a display 286 at a register if shopping at a store. In addition, it may include printing the results on a receipt using a printer 288 for the consumer to take with him. In another embodiment, it may include emailing the results, as in the case of ordering online and providing a confirmation email or in the form of a periodic statement of activity.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A method of electronic couponing and marketing, comprising:
identifying a user;
linking said user to an identifier distributed by a seller to said user;
enabling said user to search a database and select coupons;
associating said selected coupons with said user;
allowing said user to purchase items associated with said selected coupons and redeem said selected coupons;
tracking and storing information regarding said searching, said selecting and said redeeming; and
utilizing said information to generate a marketing strategy for vendors directed to users.

2. A method according to claim 1, further comprising:
providing said user with a record of said selected coupons.

3. A method according to claim 1, further comprising:
using said information to establish relative performance metrics for said coupons.

4. A method according to claim 1, further comprising:
establishing expiration dates for said coupons.

5. A method according to claim 4, wherein said expiration dates are independent of dates on which said coupons are selected.

6. A method according to claim 1, wherein said identifier is associated with an identification card having a bar code.

7. A method according to claim 1, further comprising:
informing said vendors of a value of coupons redeemed in a selected period of time using said information regarding said redeeming.

8. A method according to claim 1, wherein a value of said coupons varies according to geographic criteria of said user.

9. A method according to claim 1, wherein a value of said coupons varies according to at least one demographic criterion of said user.

10. A method according to claim 1, wherein a value of said coupons varies according to behavioral criteria of said user.

11. A method according to claim 1, wherein said marketing strategy comprises:
identifying a user that selects but does not redeem at least one of said coupons, and;
enticing said user to purchase items and redeem coupons by offering different discounts.

12. A method according to claim 1, wherein said marketing strategy comprises:
distributing advertisements or promotional items to selected users based on said information regarding said searching, said selecting and said redeeming.

13. A method according to claim 1, wherein said marketing strategy comprises:
providing a user with an additional coupon associated with an item for which said user has redeemed at least one coupon, said additional coupon having greater perceived value than said redeemed coupon.

14. A system for generating, selecting and redeeming electronic coupons, comprising:
a user interface comprising a computer with means for connecting to the Internet;
a user identification input and a user verification protocol;
a storage medium containing a first set of information comprising demographic and geographic information about said user and a second set of information comprising electronic coupons;
means for searching and selecting electronic coupons, said storage medium further containing a third set of information comprising entries representing searching and selection histories of said user;
means for associating said user identification and said selected electronic coupons with an account established by said user with a seller;
means for comparing an item selected by said user with entries of said selection history in said third set of information;
means for redeeming said electronic coupon, said third set of information further comprising entries representing a redemption history of said user.

15. A system according to claim 14, wherein said computer is a wireless communication device.

16. A system according to claim 14, wherein said first set of information is used to tailor said electronic coupons to said user.

17. A system according to claim 14, wherein said third set of information is used to tailor said electronic coupons to said user.

18. A method of electronic couponing and marketing, comprising:
obtaining individual and demographic information about a user;
authenticating said user and granting said user access to an electronic database of coupons;
enabling said user to search said electronic database and select a coupon;
associating said selected coupon with a preferred account distributed to said user by a seller;
arranging said coupons according to criteria selected by said user;
allowing said user to purchase an item associated with said selected coupon at a location operated by said seller and redeem said selected coupon;
tracking and storing searching, selection and redemption histories of said user;
informing a vendor of a value of coupons redeemed in a selected period of time using said redemption history;
using said demographic information or said searching, selection or redemption histories to modify said coupons.

19. A method according to claim 18, further comprising:
obtaining geographic information about a user.

20. A method according to claim 19, further comprising:
utilizing said demographic information, said geographic information or said searching, selection or redemption histories to provide additional incentives to said user.
